(19) United States
(12) Patent Application Publication
(10) Pub. No.: US 2014/0268157 A1
(43) Pub. Date: Sep. 18, 2014

(54) OPEN-PATH GAS ANALYZER WITH ENVIRONMENTAL PROTECTION

(71) Applicant: CAMPBELL SCIENTIFIC, INC., Logan, UT (US)

(72) Inventor: Ivan G. Bogoev, Hyde Park, UT (US)

(73) Assignee: CAMPBELL SCIENTIFIC, INC., Logan, UT (US)

(21) Appl. No.: 13/800,108

(22) Filed: Mar. 13, 2013

(51) Int. Cl. G01N 21/15; G01N 21/59

(52) U.S. Cl. CPC G01N 21/15; G01N 21/59
USPC 356/437

(57) ABSTRACT

An open-path gas analyzer is disclosed and is configured to prevent or reduce contamination of the analyzer over time.

### CROSS-REFERENCE TO RELATED APPLICATIONS

Not Applicable.

### BACKGROUND OF THE INVENTION

1. The Field of the Invention

Embodiments of the invention relate to an open-path gas analyzer. More particularly, embodiments of the invention relate to an open-path gas analyzer configured to reduce the impact of the environment or contaminants on the operation of the open-path gas analyzer.

2. The Relevant Technology

With the increase of anthropogenic green-house gas emissions, gas analyzers are widely used to measure the concentrations of these gases in the atmosphere. When a sample of a gas mixture to be analyzed is introduced into an enclosed sample volume of the gas analyzer through a tube, the gas analyzer is referred to as a closed-path design and the measurement of gas concentration is referred as ex-situ. Gas analyzers of this type are described in U.S. Pat. Nos. 6,369,387 and 5,341,214.

Alternatively, when the sampling volume of the gas analyzer is exposed to the atmosphere to be measured and the design allows the sample gas mixture to move in and out of the sampling volume freely on its own, without interfering with the flow, the gas analyzer is referred to as an open-path design. In this case the gas concentration measurement is referred as in-situ. Such analyzers are described in U.S. Pat. No. 6,317,212 and Heikinheimo.

Open-path analyzers are preferred for their simplicity, low power consumption and their ability to accurately measure rapid changes in gas concentration since there is no tubing to attenuate the high frequency concentration fluctuations. Because the sample volume of an open-path analyzer is exposed to the environment, the concentration measurement can be adversely affected by the elements, such as rain, snow, dust, pollen, etc.

Because the open-path gas analyzer operates in the open air, however, the interaction between the environment and open-path analyzer can often impact the operation of the open-path gas analyzer by fully or partially blocking the radiation (e.g., a beam of light) passing through the sample volume. More specifically, the source of the beam of light and the receiver of the beam of light are typically enclosed and protected. However, the emitter housing and the receiver housing each have a window that enables the beam of light to be transmitted, received and ultimately analyzed. Unfortunately, the windows are subject to the environment and can become contaminated.

For example, rain, snow, dew, dust, and the like can accumulate on the windows. Over time, this contamination can accumulate on the windows and block the radiation from the source, which can adversely impact the measurements taken by the open-path gas analyzer. Dew, in particular, can impact the operation of the open-path gas analyzer. When the temperature of the housing of the open-path gas analyzer decreases below the dew point of the surrounding air, dew can form a thin film of water on the windows of the open-path gas analyzer. This film of water may absorb some of the radiation being emitted by the source and reduce the strength of the signal measured by the detector. As a result, the gas concentration measurements could be compromised. Obstruction from dust, dirt, pollen, rain, snow, frost or any other form of contaminant or precipitation could cause similar effects in the operation of the open-path gas analyzer.

While the windows can be cleaned, this typically requires a user to physically visit the open-path gas analyzer and physically clean the window. Open-path gas analyzers, however, are often deployed in remote locations and in some cases on tall towers that are not easily accessible. Cleaning the windows is time consuming and can be costly. It may be necessary, for example, for a user to make sure that the device is free of dew each time a measurement is desired. What is needed are ways to keep open-path gas analyzers functioning properly and for longer periods of time without any maintenance in order to reduce the time and cost associated with operating the open-path gas analyzers.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF THE INVENTION

These and other limitations are overcome by embodiments of the invention which relate to an open-path gas analyzer configured to prevent or reduce contamination thereof. One of the advantages of embodiments of the present invention is to minimize the effects of the environment or of contamination on the measured gas concentrations and to enable embodiments of the open-path gas analyzer to operate properly and for longer periods of time.

The operation of an open-path gas analyzer is based on the fact that various gases absorb radiation (e.g., light radiation or light) at characteristic wavelengths of the electromagnetic spectrum. The intensity of the light radiation at the characteristic wavelengths is exponentially reduced by the amount of the gas present in the sample path or in the sample volume. By measuring the amount of attenuation of the light radiation passing through the sample volume containing the unknown gas mixture, the concentration of the gas can be inferred.

Open-path gas analyzers typically use a light radiation source. A plurality of filters (e.g., optical filters) are introduced sequentially in time to project a beam of light radiation with different spectral characteristics through a gas sample. The filters can alter the spectral characteristics of the radiation that is emitted into the sample volume. The filters may transmit, for example, radiation only at the specific narrow band wavelengths associated with the absorption the gas of interest. After passing through the optical filters and the gas sample, the light radiation is captured by a detector in order to determine the degree to which certain wavelengths of the light radiation transmitted through the filters are absorbed by the gas sample. The analysis of the signals received or recorded by the detector can result in information about the concentration of gases present in the sample.

In one embodiment, all of the sensitive components of an open-path gas analyzer are typically enclosed in two spatially separated housings sections. The housing sections are connected together by a support structure in a manner that allows the free flow of the sample mixture to pass between the housing sections. The volume contained between the two housings forms the measurement volume of the gas analyzer and the radiation may traverse an optical path through the measurement volume. Because the sample mixture can freely flow, the gases in sample measurement volume may constantly change. By repeatedly taking measurements, the movement or flux of gases in the environment can be determined.

In one example, the housing sections of the open-path gas analyzer are symmetrically arranged. Windows are arranged on the housing sections and radiation is configured to travel the optical path in the measurement volume between the windows.

Embodiments of the invention can prevent or reduce contamination of the windows or reduce the impact of the environment on the windows. The windows can be angled such that gravity can drain water or other contaminants from the window's surfaces. Thus, the surface of the windows may be angled with respect to a gravity vector. The window surfaces may also have a coating configured to shed the contaminants. The windows may also be at least partially enclosed by or in contact with a wicking element that wicks contaminants including water (e.g., rain or dew) away from the window.

An interface between the housing section and the window may be a smooth surface to prevent contaminants from accumulating at the interface.

In one example, heating elements may be disposed inside of the housing sections and positioned to maintain a temperature that prevents condensation from contaminating the windows or that keeps the temperature above the dew point. The open-path gas analyzer may also be sealed and include components (e.g., a scrubber) that removes certain gases from inside of the analyzer such that the measurements taken by the open-path gas analyzer correspond to the atmosphere and are not impacted by gases inside of the open-path gas analyzer. A dessicant, for instance, may remove water vapor from the open-path gas analyzer's interior while another absorber may absorb and remove carbon dioxide from the open-path gas analyzer's interior.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify at least some of the advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an example of an open-path gas analyzer;

FIG. 1B illustrates an embodiment of an open-path gas analyzer that includes symmetrically arranged housing sections;

FIG. 2 is a cross sectional view of a housing section that includes a window and that is and associated with a radiation source;

FIG. 3 is a cross sectional view of a housing section that includes a window and that is and associated with a receiver configured to detect the radiation emitted by the source;

FIG. 4 is a cross-sectional view of a housing section that includes a window and illustrates that the housing section and/or the window are configured to reduce contaminants that may interfere with measurements performed by an open-path gas analyzer; and

FIG. 5 illustrates another configuration of an open-path gas analyzer.

### DETAILED DESCRIPTION OF THE PREFERRED EMBODIMENTS

Embodiments of the invention relate to an open-path gas analyzer (also referred to herein as an analyzer or a gas analyzer) and more particularly to an analyzer that is configured to reduce the accumulation of contaminants that may adversely impact the operation of the analyzer. The analyzer can also be configured to be used in association with or integrated with a sonic anemometer or other measurement device or sensor. Advantageously, embodiments of the open-path gas analyzer described herein have a reduced size and improved structure, and can generate and collect more accurate data by reducing the impact of contaminants on the measurements performed by the open-path gas analyzer.

Embodiments of the analyzer can collect data and/or generate measurements using one or more sensors. The analyzer, for example, can be configured to measure carbon-dioxide and/or water-vapor densities, air temperature, barometric pressure, wind speed, sonic air temperature, or the like or any combination thereof. For example, the analyzer can be used to detect the concentration of water or carbon dioxide at a given time or periodically over a given time period. The data or measurements generated by gas analyzers can be used in climatology, and other disciplines.

The analyzer may also be configured to measure flux including eddy covariance flux. For example, eddy covariance flux can relate to the movement of certain gases in the atmosphere (e.g., water vapor or carbon dioxide). Direction of the flux can be determined using wind speed and wind direction measurements when wind speed and wind direction are also measured, for example, when the analyzer includes or is associated with a sonic anemometer. This enables eddy covariance flux measurements to be coupled with wind speed and/or wind direction measurements.

The analyzer, for example, can measure and calculate turbulent fluxes within the atmosphere. Flux measurements can be used to estimate and/or determine the flux of water, carbon dioxide, and other gases. The data generated by analyzers can be used in climatology, and other disciplines. For example, the analyzer can be used to detect the concentration of water at a given time. The concentration of water at a later time can be used to determine or estimate the flux between these two times and the direction of the flux. These measurements can be augmented when combined with data from an anemometer as previously mentioned.

When taking eddy covariance flux measurements or other measurements, the quality of the data can be affected by several factors. Unwanted wetness (e.g., dew, rain) that occurs in the optical path of the analyzer (e.g., on the windows of the analyzer) can potentially interfere with the gas concentration measurements. For example, if a thin layer of water is present on a surface of a window through which a beam of light or radiation passes, the thin layer of water may absorb some of the light and adversely impact the measurement taken by the analyzer.

More specifically, an analyzer performs measurements by passing radiation such as a light beam from a source to a detector through a sample measuring volume. In an open-path gas analyzer, the optical path of the light in the sample measuring volume includes the atmosphere since the sample measuring volume is located between the source and the detector. Thus, the radiation from the source passes through a first window into the atmosphere or into the sample measuring volume and from the atmosphere or from the sample measuring volume through a second window where the radiation is received by a detector.

In order to measure gas concentration, the radiation is typically centered around a particular frequency by passing the source radiation through a filter before passing through the first window of the analyzer.

To perform a measurement for water vapor, for example, measurements are taken by passing the source radiation through a filter that allows wavelengths associated with water vapor to pass. The source radiation then passes through a reference filter at a subsequent time that lets similar radiation wavelengths (which may include wavelengths near the wavelengths of the first filter) pass through. A comparison of the results will enable an accurate determination of the water vapor concentration using the difference in the absorption of the radiation at the different wavelengths. A similar approach can be used to measure concentrations of carbon dioxide in the atmosphere.

As described in more detail herein, the various filters can be mounted in a filter wheel that rotates such that the various filters are repeatedly placed in the path of the radiation over time. By coordinating the timing of the wheel with the detector, the measurements for each filter can be determined and the various measurements and comparisons can be determined. In other words, a series of filters may be mounted on an outer circumference of the filter wheel. The wheel is positioned such that the radiation emitted by the source passes through the filters disposed in the outer circumference of the filter wheel. As the filter wheel is rotated, the source radiation sequentially passes through one or more filters. In this sense, the source radiation is chopped by rotation of the filter wheel. As a result, the spectral characteristics of the radiation that enters the sample measurement volume through the window can be controlled.

As previously described, however, a thin layer of water may interfere with these measurements due to absorption of radiation that may occur in the thin layer of water. Measurements may also be influenced by other contaminants and/or by heat. Embodiments of the invention include structure or components configured to prevent the layer of water from forming or to minimize the effect of the layer of water formed in the optical path of the radiation used by the analyzer to perform measurements. Embodiments of the invention are configured to reduce the adverse impact of contaminants (including dew) on measurements performed by the analyzer including flux measurements. Embodiments of the invention may also be configured to minimize heating requirements for the analyzer.

With regard to condensation issues or to issues associated with liquid remaining on the window in various forms, embodiments of the invention are configured to prevent at least condensation from occurring on the optical windows of the analyzer. Other forms of contaminants (such as frost) can also be prevented from occurring. This is achieved using various combinations of components that can either prevent the condensation or other contaminants from forming or accumulating on the optical windows or inhibit the formation or accumulation of contaminants.

For example, a contaminant such as dew or a thin layer of water can be prevented or inhibited using a combination of heat, coatings, wicking elements, and/or an orientation of the optical window.

FIG. 1A generally illustrates an example of an open-path gas analyzer 100 (analyzer 100). The analyzer 100 may include a body 101 having a first housing section that houses a detector 102 and a second housing section that houses a light or radiation source 104. Radiation emitted by the radiation source 104 traverses an optical path 112 in a sample measurement volume. As previously stated, the sample measurement volume is part of the environment and the measurements of the analyzer 100 are performed in the open air where the air can freely flow through the sample measurement volume.

More specifically, radiation emitted by the source 104 passes through a filter 118 (which may be a plurality of filters that sequentially pass through the radiation), an optical window 116, an optical path 112 (which is open air in one example), and an optical window 114. The light is then received by a detector 102 after passing through the optical window 114.

The body 101 of the analyzer may include a first housing section 120 that is configured to house the detector 102 and a second housing section 122 that is configured to house the source 104. Other components of the analyzer 100 including, by way of example only, a controller or processor, electronics, or the like may also be disposed in the body 101 and connected to the source 104 and/or detector 102. The first housing section 120 and the second housing section 122 are connected by connectors 110, which are an example of a support structure. The connectors 110 in this example may be hollow such that air can flow freely in a sample measurement volume between the source 104 and the detector 102 and more specifically between the window 114 and the window 116. The support structure may connect the first and second housing sections in a manner that arranges the window 114 opposite the window 116. The windows 114 and 116 are arranged in the analyzer 100 in a manner that permits the radiation emitted by the source 104 to pass through a sample measuring volume disposed between the first and second housing sections 120, 122.

The analyzer 100 further includes contaminant inhibitors 106 and contaminant inhibitors 108. The contaminant inhibitors 106 and 108 are configured to protect the optical windows 114 and 116, respectively. For example, condensation (e.g., dew or a thin layer of water on the optical windows 114 and/or 116) is an example of an undesirable contaminant.

The contaminant inhibitors 106 and 108 can prevent or minimize the formation of condensation (and/or other contaminants) on the optical windows 114 and/or 116. The contaminant inhibitors 106 and 108, as discussed in more detail herein, may include one or more of a coating on the optical windows, a wicking element, a structural orientation of the windows with respect to gravity, a heating element, a scrubber, or the like or any combination thereof.

The analyzer 100 can be oriented in various configurations including vertically or horizontally. The orientation of the analyzer 100 can depend on how the windows 114 and 116 are mounted in the body 101 of the analyzer 100. Other orientations may also be considered to be within the scope of embodiments of the invention. The body 101 is configured such that the window 114 is opposite the window 116. The internal optics inside the body 101 that direct the light to the window 116 may include prisms, mirrors, lenses, or the like. Similar optics may direct the light received through the window 114 to the detector 102.

The body 101 of the analyzer 100 can be symmetric or asymmetric in configuration. In one example, the analyzer 100 can be combined with an anemometer such that wind speed and direction measurements can be taken using the same optical path 112 used by the analyzer 100. In other words, the wind speed and direction measurements correspond to the sample measurement volume and the resulting flux measurements pertain to a particular gas sample.

FIG. 1B illustrates a perspective view of an open-path gas analyzer 150 (analyzer). The analyzer 150 is an example of the analyzer 100. In FIG. 1B, the analyzer 150 includes a body 151 that includes housing sections 152, 154, and 156. The housing sections 152, 154, and 156 are connected by coupling sections 158 as illustrated in FIG. 1B such that the analyzer 150 has symmetry in at least one axis, although symmetry is not required. The coupling sections 158 are an example of a support structure that can maintain the orientation of one window relative to another window as discussed below. Each housing section 152, 154, and 156 may be hollow or partly hollow in order to accommodate various components related to the measurements being generated. The coupling sections 158 may also be hollow and may provide a conduit for electrical and/or mechanical connections.

The housing sections 152, 154, and 156 are rugged and able to withstand harsh environments. The housing sections 152, 154, and 156 may also arranged or configured in to reduce wind distortion and reduce heating concerns.

In FIG. 1B, the housing section 152 includes a window 160 and the housing section 154 is includes a window 170. The window 160 may be associated with an emitter or radiation source that emits a radiation (e.g., light radiation or light beam or radiation beam) and the window 170 may be associated with a receiver or detector that receives the radiation. In one example, each window 160 and 170 may be associated with a receiver and/or an emitter. The radiation from the source passes through the window 160 into the sample measurement volume and is received by the detector through the window 170 from the sample measurement volume.

The characteristics of the light beam emitted by the radiation source are typically known or determined. The characteristics can be determined at the time of emission or predetermined or calibrated as needed. The calibration may be done automatically by a controller or processing system housed, for instance, in the housing section 156.

The emitted light beam is directed to and received through the window 170 at a receiver or detector. The receiver may include a sensor that can analyze the received light beam based on various factors. For example, intensity, wavelength, time, or the like are measured when the light beam is emitted and received. The sensed characteristics of the received light beam can be indicative of, by way of example only, carbon-dioxide densities, water-vapor densities, or the like.

The housing sections 152 and 154, in which the windows 160 and 170 are mounted, respectively, are arranged such that the windows 160 and 170 are opposed to each other or such that the window 160 faces the window 170. The window 160 can be directly opposed to the window 170. However, the window surfaces may not be parallel to each other while still being opposed to each other. This ensures that the window 160 can be mounted on or coupled to the housing section 152 such that the window 160 faces the window 170 that is mounted on or coupled to the housing section 154. The housing section 152 and the window 160 may be a single component or formed from a single body. The housing section 152 may have an opening formed therein that is shaped and configured to receive the window 160. Similarly, the housing section 154 and the window 170 may also be a single component. The housing section 154 may have an opening formed therein that is shaped and configured to receive the window 170.

The distance between the window 160 and the window 170 is typically known or determined during manufacture of the analyzer 150 or during calibration of the analyzer 150. Changes in the distance due to changes in temperature (e.g. material contraction or expansion) can be accounted for by a controller if necessary or during periodic calibrations.

The window 160 and the window 170 may each configured to prevent or reduce the impact of contaminants on the performance of the analyzer 150. The window 160 is mounted in a portion 162 of the housing section 152 and the radiation passes through the window 160 when the radiation is emitted. In one example, the portion 162 of the housing section 152 may protrude from the housing section 152 and may be configured to hold the window 160 and may be configured to hold the window 160 such that the window 160 has a particular orientation relative to a gravity vector. The window 170 may similarly be mounted in a portion 172 of the housing section 154. The emitted light beam is received through the window 170. The portion 172 of the housing section 154 and the portion 162 may be similarly configured and may facilitate transmission of the radiation. The portions 162 and 172 may, for example, aid in preventing ambient light from affecting the measurements performed by the analyzer 150. The portions 162 and 172 may extend from a surface of, respectively, the housing sections 152 and 154. The windows 160 and 170 may be mounted in distal ends of the portions 162 and 172, respectively. The windows 160 and 170 may be glued to the portions 162 and 172. The portions 162 and 172 are also examples of housing sections that can be part of a larger body or a larger housing section.

When the windows 160 and 170 are dirty or contaminated, the measurements of the analyzer that are determined from the radiation passing through the optical measurement volume may be adversely affected. Accordingly, the analyzer 150 is configured with components or contaminant inhibitors that help prevent or inhibit contamination of the windows 160 and 170 or that extend the period during which accurate measurements may be determined by slowing the rate at which the windows 162 and 172 become contaminated. In one example, these components can act on more short-term or recurring contaminants such as condensation (e.g., dew) in addition to inhibiting contaminants that accumulate over a longer time period. By preventing or inhibiting condensation, the measurements taken by the analyzer are more accurate and reliable. In addition, some of the contaminant inhibitors may be applied directly to the windows 160 and 170. Other contaminant inhibitors may be located near the windows 160 and 170 and may be in physical contact with the windows 160 and 170. Some of the contaminant inhibitors may not be in contact with the windows 160 and 170.

Generally, the window 160 and the window 170 are configured to be free of or substantially free of contaminants (e.g., water, dew, rain, snow, dirt, or the like or combination thereof). Substantially free may indicate that measurements of the analyzer are not unacceptably affected by any contaminants that may be present or that may have accumulated on the windows 160 and 170.

First, the window 160 is configured and mounted such that the window 160 or a surface of the window 160 is mounted at an angle with respect to gravity or to a gravity vector. This orientation of the window 160 enables water or forms thereof such as condensation to roll off of the window 160 under the effect of gravity. In addition, the window 160 may have one or more coatings formed or deposited on an external surface of the window 160 (the surface exposed to the environment). The coatings may include, by way of example only, a hydrophobic coating, an oleophobic coating, and/or a non-stick coating. The coatings may increase a contact angle of the window surface to improve repelling properties of the window 160 The hydrophobic coating aids in keeping water off of the window 162 and repels water. The oleophobic coating repels oils. The hydrophobic coating can also reduce residue related to dissolved salts that may be in the water. Different portions of the window may have different coatings.

A wicking element 166 may be disposed on at least a portion of an outer surface of the window 160 (or more generally the housing section 152 and/or the portion 162 of the housing section 152. More specifically, the wicking element 166 is disposed or placed next to a perimeter (e.g., a circumferential) edge of the window 160. As water rolls off of the window 162 or as water is present on the perimeter edge of the window 160, the wicking element 166 can wick the water away from the window 160 or the window's surface.

In addition, a heater (which may be a local heater in proximity to the window 160) can keep the temperature at a certain level or above a certain point or prevent condensation or water from forming on the window 160. For example, the heater may be configured to keep at least the window above a dew point of ambient air so as to prevent condensation on the window 160. The heater or heating element may also increase a temperature of other components. The data collected by the analyzer 150 can be compensated for the heat if necessary using, for example, BAXD1 or BAXD2 corrections.

Each of these components, alone or in combination, prevents the window 160 from being contaminated or at least reduces the rate at which the window 160 is contaminated. The heating element can be configured to be used only during certain conditions and/or times to reduce the influence of the heating element on the measurements. For example the heating element may be turned off when dew is unlikely to form. This can be based on a sensed temperature, for example.

The window 170 or the housing section 154 is similarly configured. The window 170 may include or be associated with or in contact with a wicking element 176. The window 170 may have one or more coatings and the window 170 may be located near a local heater element, and may be angled with respect to gravity or a gravity vector. These components or contaminant inhibitors cooperate in a manner similar to the wicking element 166, the coating of the window 160, and the local heater element of the window 160.

In one embodiment, the housing sections 152 and 154 are arranged such that one of the sections is vertically displaced from the other section when the analyzer 150 is deployed for operation. Thus, the window 160 is typically placed vertically above the window 170 or vice versa.

A distance between the housing section 152 and the housing section 154 can be, by way of example only, between 5-10 inches. In one embodiment, the distance is between 5-8 inches, with the diameter of each housing section 152 and 154 being 1.25 inches, and the length of each housing section being approximately 12 inches. These dimensions are provided by way of example only and other dimensions are within the scope of the invention. The windows 160 and 170 may be mounted on or near ends of the housing sections 152 and 154. In addition, the geometries of the housing sections and the windows can vary and are not limited to a specific geometry. The windows 160 and 170, for example, can be circular, elliptical, or another shape. The housing sections can by cylindrically shaped or have another shape. The housing sections can also be oriented, by way of example only, horizontally or vertically.

As previously stated, some of the coupling sections 158, which are example of support structures that are arranged such that the window 160 is arranged to oppose the window 170 may be at least partially hollow to permit for the electrical connection of the components within the housing sections 152, 154, and 156. In this manner, electrical power can be provided to power the emitter and the receiver and the controller. The analyzer 150 may also house a data logger to store the measurements over time. The power can be provided by a battery, via solar panels, batteries that are recharged via the solar panels, or the like.

The housing sections 152, 154, and 156 and the coupling sections 158 may be configured to ensure that any gas within the housing section 152 is not passed to the housing section 154 and vice versa. At least one of or a portion of the housing sections 152, 154, and 156 may also be hermetically sealed.

A scrubber may also be disposed inside of the analyzer 150. The scrubber may remove certain gases from inside of the analyzer 150 such that these gases do not interfere with measurements taken by the analyzer. For example, if carbon dioxide is present inside of the analyzer 150 and in the path of the light from the light source to the optical window or from the optical window to the detector, then the measurements will be adversely affected. The scrubber removes these gases from the environment inside of the analyzer 150. A dessicant may remove water vapor and a carbon dioxide absorber can be used to absorb carbon dioxide. The body 151 may thus be sealed in a manner that prevents these gases from being introduced inside the analyzer 151 or that reduces the rate at which these gases are introduced. Even if these gases are introduced, the scrubber can remove them at an adequate rate.

An open-path gas analyzer typically measures gases that are in the open or in the atmosphere. In this example, an optical path 180 is formed between the housing section 152 and the housing section 154 or more specifically between the window portion 160 and the window portion 170. The optical path 180 passes through a sample measurement volume. The optical path 180 acts as an open-air measuring region. In this configuration, gas (e.g., air or gases therein) is allowed to flow freely between the housing sections 152 and 154. The sample gas is thus constituted by the freely flowing air, which passes through the optical path 180 or through the optical or sample measurement volume. By passing an optical beam of light on the path 180, information about gases in the environment can be determined and measured.

FIG. 2 illustrates a cross-sectional view of the housing section 152 or more specifically of an end of the housing section 152. The window 208 can be mounted in the end or in another portion of the housing section 152. More generally, the windows can be disposed in various locations in the housing sections. The windows can be disposed in the ends, on distal ends of protrusions or other portions extending from a main body of the housing sections, in center portions of the housing sections, or the like. However, regardless of where the windows are located in the housing sections, the windows are arranged such that radiation passing through one of the windows is received through the other window.

FIG. 2 illustrates a light or radiation source 202 that is configured to generate or emit radiation, which may be within a particular wavelength range. The radiation source 202 is typically disposed inside of the housing section 152. The light or radiation emitted by the radiation source 202 may include a range of wavelengths. Because certain wavelengths may be useful for certain measurements, the light emitted by the radiation source 202 may be filtered and/or directed by optics 204 to the window 208.

The radiation source 202 may include an infrared radiation source which is driven at a consistent wattage. Alternatively, the radiation source 202 may include a near infrared light source, an ultraviolet light source, and/or any other suitable light source that emits light at any desired wavelength or range of wavelengths.

The optics 204 may include mirrors, prisms, reflectors, filters (including reference filters for calibration purposes or comparison purposes) and/or other components that can be selectively configured to control the emitted radiation beam from the radiation source 202. In other words, the filters may alter the spectral characteristics of the emitted radiation. For example, the filters can be configured or selected to allow a particular wavelength or wavelength range to pass when measuring carbon-dioxide density and to allow another wavelength or wavelength range to pass when measuring something different. The optics 204 may include a final lens 206 that focuses (e.g., collimates) and directs the light beam out of the window 208 and over the optical path 180.

In one example, the optics 204 includes a rotatable filter wheel 220. Depending on the desired wavelengths, the filter wheel 220 can be rotated as needed or be rotated continuously. In this example, the rotation of the filter wheel 220 is tracked such that the emission of radiation through a particular filter is marked in time and can be correlated with the detected radiation. The filter wheel 220 may also include reference filters. The filters in the filter wheel 220 are represented by filters 224 and 226. The optics 204 can therefore be configured such that various combinations of wavelengths (e.g., certain wavelengths or ranges of wavelengths), are transmitted through the window portion 160 after passing through the filters in the filter wheel 220. In addition, the timing at which the light passes through the window portion 160 can also be controlled and monitored.

The filter wheel 220 may be a flat circular plate or have a curved and cup-shaped body. By curving the body, the space required for the filter wheel 220 can be reduced, which advantageously reduces the size of the analyzer 150. FIG. 2 illustrates a mirror 222 that is placed inside a body of the filter wheel 220. The filter wheel 220 is arranged with respect to the mirror 222 such that radiation from the source 202 is reflected by the mirror 222 to pass sequentially through the filters 224 and 226 as the filter wheel 220 rotates. The filter wheel 220 can be configured with one or more filters and the radiation passes through the filters sequentially. In one example, sufficient filters may be included in the filter wheel 220 to allow one or more gasses or concentrations thereof to be measured by the analyzer 150.

The window 208 may be mounted in a portion 214 of the housing section 152 that is connected to or integrated with a body of the analyzer. The housing section 152 is typically impermeable to water and air. This protects components inside of the housing section 152 from the environment and can impede the introduction of exterior gases to the interior of the housing of the analyzer 150. The portion 214 can be round, elliptical, square, rectangular, or the like. The body of the portion 214 is hollow such that the radiation emitted by the radiation source can pass through the portion 214 and through the window 208 mounted in the distal end of the portion 214.

More specifically, the portion 214 may define a passage for the radiation emitted by the source 202. The portion 214 may extend outwardly from the main body of the housing section 152 and the window 208 is mounted in a distal end of the portion 214. The window 208 is mounted in the portion 214 or in the housing section 152 in a manner that prevents contaminants from entering inside of the analyzer 150. The window 208 is sealed to the portion 214 or to the housing section 152 in one example.

Generally, the windows discussed herein may be formed of different material including by way of example only, glass or sapphire. The window 208 may include, for example, a glass or sapphire plate 218, which may have different shapes. A coating 212 (e.g., hydrophobic, oleophobic, non-stick, or the like or any combination thereof) is formed on a surface of the window 208 that is exposed to the environment. A circumferential edge 216 of the plate 218 or of the window 208 is adjacent or in contact with a wicking element 210. The wicking element 210 may be in contact with the perimeter edge 216 and/or with a portion of the exposed surface of the window 208. The wicking element 210 has a body that conforms to a shape of the portion 214 or that conforms to a shape of the portion of the housing section 152 on which the window 208 is located. The wicking element 210 may be formed of a stretchy material that, when placed around with window 208, contracts around the portion 214 or the housing section 152 such that the wicking element 210 is held in place with respect to the window 208 without blocking the window 208. The position of the wicking element 210 can be altered by a user, however. In addition, because the wicking element 210 is exposed to the environment, the wicking element 210 can be replaced as needed.

Advantageously, moisture or water that contacts the wicking element 210 at the perimeter edge 216 is wicked away from the window 208. This can reduce the occurrence of dew formation on the window. The length of the wicking element 210 may extend on the body of the housing section 152 with sufficient length to keep the wicking element 210 in place in order to enable the wicking element 210 to wick or carry moisture away from the window 208. The wicking element 210 may also be shaped to accommodate a shape of the housing section 152 or a portion thereof in which the window 208 is mounted. For example, the wicking element 210 may have an angled portion to accommodate an angled orientation of the window 208.

FIG. 3 illustrates a cross sectional view of window 306, which is an example of the window 170 and an end of the housing section 154. The window 306 and the window 208, which is an example of the window 160, may be similarly configured with respect to contamination prevention or contamination control. In one example, the window 306 may be mounted in a portion 310 of the housing section 154 that extends from a main body of the housing section 154. The housing section 154 may also include components disposed inside the housing section 154 that are configured to receive the radiation beam and direct the radiation beam for analysis. The window 306 may be an integral part of the housing section 154 (the window 208 is similarly configured in the housing section 152) or may be a separate component that is attached to the housing section 154.

The radiation originating from the radiation source 202 is received through the window 306. Optics 316 may be included in the housing section 154 that are configured to direct the received radiation to the sensor 320. The optics 316 may include, for example, an off-axis parabolic mirror 318 that reflects and focuses the light beam to a sensor 320 in this example. The sensor 320 may include a light detector (e.g., a photodetector) that is configured to be responsive to certain wavelengths of light or to certain ranges of wavelengths. The sensor 320 captures the transmitted light and converts the light to an electrical signal. The electrical signal may be processed by a processing unit, which may include a data logger, to determine the amount of light absorbed by the gas sample in the optical path 180 or in the sample measuring volume. The sensor 320 may have a high sensitivity and reduced noise capabilities. Using this information, certain characteristics about the gas sample can be determined.

The window 306 may be mounted in a tubular portion 310 (which may have other shapes) of the housing section 154. The housing section 154 including the portion 310 is typically waterproof and/or airproof to protect an interior of the analyzer from the environment (which may adversely affect measurements).

The window 306 includes a thin sapphire plate (e.g., a sapphire disk or other shape and/or other suitable material) 304 mounted in a distal end of the portion 310 or that may be mounted, like the window 208 may be mounted in a surface of the housing section 152, in a surface of the housing section 154. The plate 304 may have a coating 302 (e.g., a hydrophilic, oleophobic, non-stick coating or the like or any combination thereof) disposed on an exterior surface of the window 306. As previously described, the coating 302 and the angle of the window 306 relative to the ground or with respect to the gravity vector help shed water from the exterior surface of the window 306 and help prevent contamination of the window 306.

A perimeter edge 312 of the window 306 may be adjacent to or in contact with a wicking element 308 that is similar to the wicking element 210. The entire perimeter edge 312 or a portion thereof and/or a portion of the exterior surface of the window 306 may be in contact with the wicking element 308. This contact enables the wicking element 308 to draw moisture or water away from the window 306 or to draw away any water that may accumulate at the circumferential edge 312.

FIG. 4 illustrates another example of a window 424 that is mounted in a housing section or in a portion 400 of the housing section 402. The window 424 (which is an example of the window 160 and/or 170) may be mounted in the housing section 402 and, in one example, may be mounted in a portion 400 of the housing section 402. The portion 400 may include a hollow body 416 that is mounted on or that extends from a main body of the housing section 402 (which is an example of the housing section 152 and 154). The body 416 extends orthogonally, in one example, from a longitudinal axis 418 of the housing section 402 in one example. The arrangement of the components of the analyzers discussed herein can vary and may depend on the orientation of other components. Thus, the body 416 may extend at an angle depending on an orientation or configuration of the housing section 402.

The housing section 402 including the portion 400 is substantially impermeable to water and air. The body 416 may be screwed into the housing section 402, sealed, welded, glued, integrally formed with, or otherwise affixed to the housing section 402.

The distal end 422 of the body 416 is angled at an angle 414. This allows the window 424 to be mounted at the angle 414 with respect to gravity or with respect to a gravity vector when the analyzer is properly deployed. In addition, the window 424 includes a plate 404 (e.g., a glass plate or a sapphire plate or a plate of another material) and a coating 426 (e.g., hydrophobic coating, oleophobic coating, non-stick coating or the like or any combination thereof) formed on the plate 404. When oriented vertically, water on the window 424 is runs off of the window 424 due to gravity and/or the coating 426.

The window 424 is mounted in a distal end of the body 416. The window 424 is substantially flush with the body 416 or flush with a surface of the housing section 402 such that water is not trapped in a crevice between the window 424 and the body 416 or the housing section 402. A smooth transition 408 from the window 424 to the body 416 aids in minimizing contamination of the window 424.

The window 424 also includes a wicking element 406. The wicking element 406 may be formed of any suitable material and is typically formed in a shape that is undersized relative to the portion of the housing section on which the wicking element 406 is placed. As a result, the wicking element 406 is stretched over the housing element 402 (e.g., the body 416) and can be held in place by friction. A portion 412 of the wicking element 406 may be formed of rubber or other material to further aid in maintaining the position of the wicking element 406 relative to the window 424.

The coating 426, the angle 414 of the distal end 422, the transition between the window 424 and the body 416, and the wicking element 406 contribute to keeping the window 424 free from contaminants or at least reduce a rate of contaminant accumulation.

A heating element 420 may also be included to reduce contamination of the window 424. The heating element 420 can be placed underneath the window 424 inside of the housing section 402. This enables the window 424 to be heated by convection and radiation. The heater element 420 can be a resistor coupled to a heat sink. In one example, the heater element 420 does not touch any part of the window 424. Alternatively, the heating element 420 can be mounted at another location (e.g., on or in an interior wall of the body 416 or of the housing section 402) without interfering with the optical path of the radiation.

At a minimum, these components ensure that a rate at which the window 424 becomes contaminated with water, dirt, salts, etc., is reduced. These components or portions thereof may reduce or prevent the occurrence of temporary contaminants such as condensation. This can lower the cost of operating the analyzer 150 by reducing the frequency with which the analyzer 150 must be manually cleaned.

In one example, the gas analyzer 150 has a symmetrical shape in the lateral direction in an embodiment. With reference to FIG. 1B, the angles of the windows 160 and 170 may be parallel or arranged opposite to each other. More specifically, the housing section 152 is similar to the housing section 154 even though the internal components may differ. For instance, one of the housing sections 152 and 154 includes a light source and the other of the housing sections includes a detector. The detector may include a filter that prevents, for example, sunlight from interfering with the measurements taken by the analyzer.

The operation of the analyzer 100 or of other analyzers disclosed herein, with reference again to FIG. 1A, may occur as follows. The source 104 emits light or radiation and the filter device 118 (e.g., a filter wheel) rotates such that the filters mounted in the filter device 118 are placed in the path of the light or radiation in sequence. The filter device 118 may include a plurality of individual filters. In one example, the individual filters may include a filter that passes wavelengths of light specific to a first gas such as carbon dioxide. Another filter may pass wavelengths specific to a second gas such as water vapor. One or more reference filters may pass the same or nearby wavelengths. The filter for carbon dioxide, for example, may be associated with one or more reference filters.

The detector 102 detects the emitted light and the output of the detector 102 is correlated to the rotation of the filter device 118 and to specific filters in the filter device 118. The concentration of carbon dioxide or water vapor can be determined by determining the difference in the absorption of the two wavelengths of light that pass through the carbon dioxide filter and one of the reference filters. In this manner, the concentration of a gas can be measured. By accumulating measurements over time, a picture of how the gases vary over time can be determined. When combined with wind measurements, eddy covariance flux measurements can be logged.

Although FIGS. 2-4 illustrate that the windows are mounted in a portion of the housing section that extends from a main body of the housing section, one of skill in the art can appreciate, with the benefit of the present disclosure, that many other configurations of the housing sections are within the scope of the invention. Generally, the various arrangements are configured such that the window associated with the radiation source opposes the window associated with the detector or receiver. This arrangement ensures that the radiation passes through an optical measurement volume in a consistent manner.

The housing sections can therefore vary in shape. Similarly, the shape of the wicking element may also vary to accommodate the shape of the housing sections in which the windows are disposed. As necessary, the housing section may be provided with hooks or other features that can aid in securing and holding the wicking element in place in a manner that ensures that the water layer can be wicked.

In one example, the windows are mounted in the housing sections such that an exterior surface of the housing sections is substantially flat. In other words, the portions illustrated in FIGS. 2-4 can be eliminated. For instance, the housing sections may be arranged in a “V” configuration such that the windows are opposed to each other and angled with respect to gravity when properly deployed.

FIG. 5 illustrates another embodiment of an open-path gas analyzer 500, which is an example of the analyzer 100. In FIG. 5 a window 502 is mounted in a surface of a housing section 506 and a window 504 is mounted in a surface of the housing section 508. The windows 502 and 504 may be substantially flush with the surfaces of the housing sections 506 and 508. Alternatively, the windows 502 and 504 may extend slightly above the surface of the corresponding housing section.

In FIG. 5 a support structure 512 connects the housing sections 506 and 508, which are arranged in a “V” configuration, and can secure a position of the window 502 relative to the window 504. FIG. 5 illustrates that the windows 502 and 504 are opposed to each other such that an optical measurement volume 510 is disposed between the windows 502 and 504 and such that radiation emitted through the window 502 passes through the optical measurement volume 510 and is received through the window 504 (or vice versa). FIG. 5 also illustrates wicking elements 514 and 516 that are adapted to a shape of, respectively, the housing sections 506 and 508 and that are configured to wick moisture from the windows 502 and 504.

The embodiments described herein may include the use of a special purpose or general-purpose computer including various computer hardware or software modules which may be used in association with a processor or datalogger in order to analyze the data collected from the gas analyzer described herein.

Although these components are described generally herein, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A gas analyzer comprising:
a first housing section;
a second housing section spatially separated from the first housing section, wherein the first housing section and the second housing section are arranged to form an optical measuring volume between the first and second housing sections;
a source disposed in the first housing section, the source configured to emit radiation;
a detector disposed in the second housing section and configured to detect the radiation;
a first window disposed on the first housing section, the first window allowing the radiation from the source to be transmitted into the optical measuring volume;
a second window disposed on the second housing section, the second window being opposed to the first window, the second window allowing radiation from the source to be received by the detector;
a support structure coupling the first housing section to the second housing section, the support structure enabling a sample gas to pass between the first and the second housing sections in the optical measuring volume;
wherein at least one of the first window or the second window includes a coating, the coating bonding to a window surface and altering properties of the window surface to repel contaminants from the window surface.

2. The gas analyzer of claim 1, wherein the coating includes a hydrophobic coating that increases a water contact angle of the window surface and that repels water from the window surface.

3. The gas analyzer of claim 1, wherein the coating includes an oleophobic coating that increases an oil contact angle of the window surface and that repels oil from the window surface.

4. The gas analyzer of claim 1, wherein the coating includes a non-stick coating that repels dust, dirt and particulates from the window surface.

5. The gas analyzer of claim 1, wherein the first window and the second window comprise sapphire.

6. The gas analyzer of claim 1, wherein the window surface of the first window and the window surface of the second window are flat.

7. The gas analyzer of claim 6, wherein the window surface of at least one of the first window or the second window is not perpendicular to a gravity vector.

8. A gas analyzer comprising:
a first housing section;
a second housing section spatially separated from the first housing section, wherein the first housing section and the second housing section area arranged to form an optical measuring volume between the first and second housing sections;
a source disposed in the first housing section, the source configured to emit radiation;
a detector disposed in the second housing section and configured to detect the radiation;
a first window disposed on the first housing section, the first window allowing the radiation from the source to be transmitted into the optical measuring volume;
a second window disposed on the second housing section, the second window being opposed to the first window, the second window allowing the radiation from the source to be received by the detector; and
a support structure coupling the first housing section to the second housing section, the support structure enabling a sample gas to pass between the first and the second housing sections in the optical measuring volume;
a wicking element disposed in proximity to at least one of the first window or the second window,
wherein the wicking element enables liquid contaminants to be wicked away from an exterior surface of at least one of the first window or the second window;

9. The gas analyzer of claim 8, wherein the wicking element is removably disposed on one of the first housing section or on the second housing section.

10. The gas analyzer of claim 8, wherein the wicking element includes a fabric.

11. The gas analyzer of claim 8, where the wicking element wicks liquid water.

12. The gas analyzer of claim 8, where a window surface of the first window and a window surface of the second window are flat.

13. The gas analyzer of claim 8, wherein the window surface of at least one of the first window or the second window is not perpendicular to a gravity vector.

14. A gas analyzer comprising:
a first housing section;
a second housing section that is substantially identical to the first housing section, wherein the second housing section is symmetrically arranged and spatially separated from the first housing section to form an optical measuring volume between the first and second housing sections;
a source disposed in the first housing section and configured to emit radiation;
a detector disposed in the second housing section and configured to detect the radiation;
a first window disposed on the first housing section, the first window allowing the radiation from the source to be transmitted into the optical measuring volume;
a second window disposed on the second housing section, the second window being opposed to the first window, the second window allowing the radiation from the source to be received by the detector;
a support structure coupling the first housing section to the second housing section, the support structure enabling a sample gas to pass between the first and the second housing sections in the optical measuring volume;
a first heating element disposed in proximity to the first window and configured to increase a temperature of the first window;
a second heating element disposed in proximity to the second window and configured to increase a temperature of the second window; and
a controller configured to control a power to the first and the second heating elements so that the temperature of the first window and the temperature of the second window are maintained above a dew point or a frost point of the sample gas in the optical measuring volume.

15. The gas analyzer of claim 14, where the first heating element is disposed inside the first housing section.

16. The gas analyzer of claim 14, where the second heating element is disposed inside the second housing section.

17. The gas analyzer of claim 14, wherein the first heating element and the second heating element are configured to generate sufficient heat to prevent condensation on, respectively, the first window and the second window.

18. The gas analyzer of claim 14, wherein the first heater element and the second heater element are thermally decoupled from the first housing and the second housing respectively.

19. The gas analyzer of claim 14, wherein the first heating element and the second heating element each include a resistor and a heat sink.

20. A gas analyzer comprising:
a first housing section;
a second housing section symmetrically arranged with respect to the first housing section and opposing the first housing section;
a first window disposed in the first housing section;
a second window disposed in the second housing section, wherein the first window is arranged to oppose the second window; and
first components arranged in proximity of the first window; and
second components arranged in proximity of the second window, wherein the first components and the second components are arranged to reduce contamination of, respectively, the first window and the second window.

21. The gas analyzer of claim 20, wherein:
the first components for the first window portion include a first coating formed on the first window, a first wicking element removably disposed on an exterior surface of the first housing section and in contact with the first window and a first heating element disposed inside the first housing section; and
the second components for the second window portion include a second coating formed on the second window, a second wicking element removably disposed on an exterior surface of the second housing section and in contact with the second window and a second heating element disposed inside the second housing section.

22. The gas analyzer of claim 21, wherein the first coating and the second coating are at least one of hydrophobic, oleophobic, or non-stick and are configured to shed the contaminants from the first window and the second window.

23. The gas analyzer of claim 21, wherein the first housing section include a distal end and the first window is mounted in the distal end, wherein the second housing section includes a distal end and the second window is mounted in the distal end, wherein the distal ends are angled with respect to a gravity vector to aid in shedding the contaminants.

24. The gas analyzer of claim 21, wherein the each first and second wicking elements include a first material configured to wick water and a second material configured to position grip the first and second housing sections.

25. The gas analyzer of claim 24, wherein the first material is held in place by friction and is sized such that the first material contracts against the first window portion.

26. The gas analyzer of claim 20, wherein the first window is associated with emitter source that generates a light beam and the second window is associated with a receiver that receives the light beam after the light beam passes through a sample gas in an optical measuring volume between the first housing section and the second housing section.

27. The gas analyzer of claim 26, further comprising a controller configured to derive measurements from the light beam that travels through the optical measuring volume between the first window and the second window.

28. The gas analyzer of claim 21, wherein the first and second heating elements are configured to heat by at least one of radiation or convection and are configured to emit sufficient heat to prevent condensation on the first and second windows.
